(19) United States
(12) Patent Application Publication
(10) Pub. No.: US 2019/0118131 A1
(43) Pub. Date: Apr. 25, 2019

(54) SUCTION DEVICE HAVING A HOUSING WHICH ENCLOSES A PROCESS CHAMBER

(71) Applicant: ESTA Apparatebau GmbH & Co. KG, Senden (DE)

(72) Inventors: Frederik SCHAUB, Buch (DE); Sebastian KRATER, Staig (DE)

(21) Appl. No.: 16/301,616

(22) PCT Filed: Apr. 10, 2017
(86) PCT No.: PCT/DE2017/100285

§ 371 Date: Nov. 14, 2018

(30) Foreign Application Priority Data
May 20, 2016 (DE) 10 2016 109 380.7

(51) Int. Cl. B01D 50/00; B01D 45/16; B01D 46/00; B01D 46/24; B04C 3/06; B04C 9/00

(52) U.S. Cl. CPC B01D 50/002; B01D 45/16; B01D 46/0046; B04C 2003/003; B04C 3/06; B04C 9/00; B01D 46/2403

(57) ABSTRACT

The invention relates to a suction unit (1), having a housing (3) which encloses a process chamber (2) and has at least one volume flow inlet (4) and at least one volume flow outlet (5), wherein the housing (3) conducts the volume flow and, to this end, has a helical contour (32) with at least one turn (31), the at least one volume flow inlet (4) is arranged at the upper end of the helical contour (32) such that the volume flow is introduced tangentially and is conducted downwards along the helical contour (32) inside the process chamber (2), and the volume flow outlet (5) is arranged on the helical axis (33) of the helical contour (32), and a filter body (6) is arranged upstream of the volume flow outlet (5) in the interior of the process chamber (2) through which filter body (6) the volume flow is conducted.

The invention relates to a suction device, comprising a housing enclosing a process chamber with at least one volume flow inlet and at least one volume flow outlet.

Depending on the application, extraction and filtration devices are used for extraction and filtration of chips, fibers, coarse particles of all kinds, smoke components, sparks, liquids and the like. If these products in a suction device reach directly one or several often small-pored filter elements, made of sensitive materials, the latter will be heavily loaded, which can lead to reduced service life, premature wear or even damage to the filter element. For this reason, devices of this type are often equipped with additional pre-separator and/or pre-filters, for example a so-called demister mat. This is technically complex and costly to maintain.

DE-OS 705 339 discloses a centrifugal dust separator with a process chamber in which a housing directs the flow and to do so, helical turns are provided in the cylindrical housing.

The object of the invention is to provide an improved suction device, in which an improved particle pre-separation is ensured in front of the filter bodies.

This object is achieved by a suction device according to the features of claim 1.

According to the invention, a suction device with a housing enclosing a process chamber and having at least one volume flow inlet and at least one volume flow outlet, is provided, which distinguishes itself in that the housing directs the volume flow and for this purpose has a helical contour having at least one turn, wherein said at least one volume flow inlet is arranged at the upper end of the helical contour so that the volume flow is introduced tangentially and is guided downwards along the helical contour in the process chamber, wherein the volume flow outlet is arranged on the screw axis of the helical contour, wherein the volume flow outlet is arranged at the lower end of the housing on the screw axis of the helical contour.

For the purposes of the invention, the housing or the helical contour is aligned at an angle of 0° to 60° of the screw axis against the vertical.

The internal shape of the housing accordingly generates an air and particle flow in such a way that as many particles as possible are pre-deposited by the positive guidance and thus the filter elements are protected as comprehensively as possible from the aforementioned products. In addition, the pressure stability of the housing is increased by its curved shape.

The housing has a spiral-shaped inner contour, in whose central axis or in the vicinity of a filter element is located. The particle flow passes from the suction opening in the upper region along the spiral shape of the housing into the lower region. Due to said at least radii/tangential entry of the raw gas stream into the housing and the forced spiral movement, heavier particles are pressed by centrifugal forces outward against the housing wall and slowed down there and pass through the spiral or screw housing shape downwards. There larger particles are safely separated without adding the filter body (bodies).

With the use of the proposed housing concept, separate or integrated presplate sheets, spark guards, and the like, as previously required, are no longer required.

The housing concept combines the separation of particles by centrifugal forces and by a filtering medium in the smallest chamber.

Since the actual filter element is relieved, the filter life increases significantly.

A variant of the invention provides that a plurality of volume flow inlets are arranged at the upper end of the vertically arranged helical contour.

A particularly preferred development of the invention provides that a filter body is arranged in front of the volume flow outlet in the interior of the process chamber, through which the volume flow is guided.

It is advantageously provided that the walls of the housing forming the helical contour bear against a cylindrical filter body inserted therein in the process chamber.

Another advantage brought about by this is that the functional ribbing (helical shape) and the inclusion of the cartridge (filter body) as a structurally effective element can achieve material savings at a comparable low pressure level and/or the negative pressure stability is greatly increased compared to other shapes.

Due to the special shape and the concerns on the filter body, a static function is adopted. The housing is thus much more pressure stable than would be the case without the support. As a result, it is possible, for example, to obtain higher negative pressures or to achieve material savings in the housing, since the housings are also operated with reduced wall thicknesses without any loss of function. The functional ribbing itself in the form of constrictions also significantly increases the vacuum resistance.

Preferably, a closable opening for emptying the process chamber is arranged in the lower region of the process chamber. As a result, accumulated materials can be easily removed from the process chamber.

A particularly advantageous embodiment of the invention provides that the housing is formed in one piece or of two integral partial elements. This allows a cost-effective and easy-to-use production, for example in the form of half-shells.

Advantageously, a flange is integrally formed in the lower region of the housing, which can cooperate with a bearing formed on a holding device for the housing in such a way that the housing can be tilted.

Preferably, after the volume flow outlet at the lower end of the housing, a fan generating the volume flow is arranged.

The useful life and service life are advantageously increased if, as proposed according to a variant of the invention, a dirt collecting formation of the process chamber for solid and liquid substances separated from the volume flow is formed in the lower region of the housing.

Further advantageous embodiments will become apparent from the other dependent claims or their possible sub-combinations.

The invention will be depicted below using the drawings. In detail, the diagrammatical illustrations are as follows:

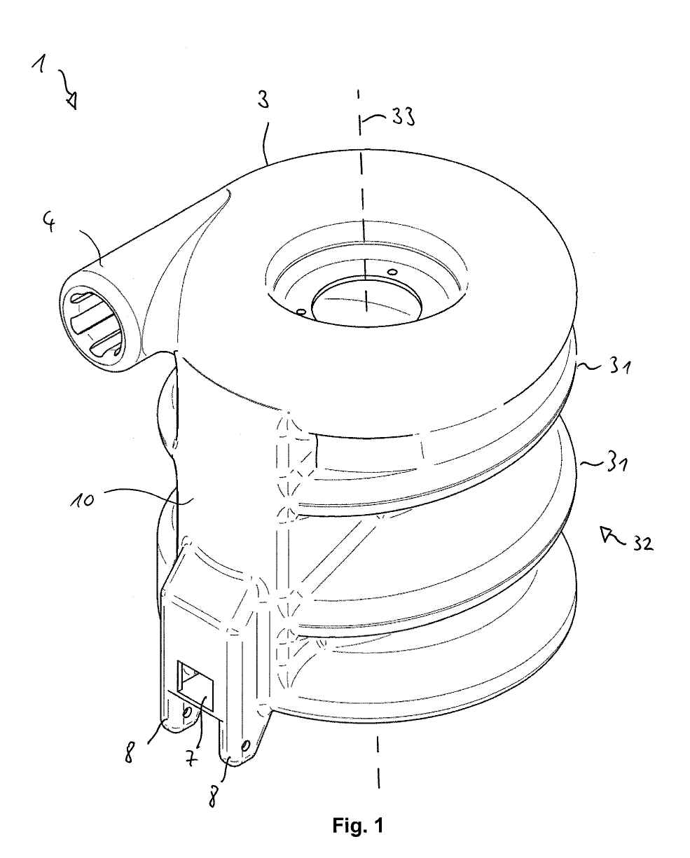

FIG. 1 is a schematic oblique view of a suction device according to the invention,

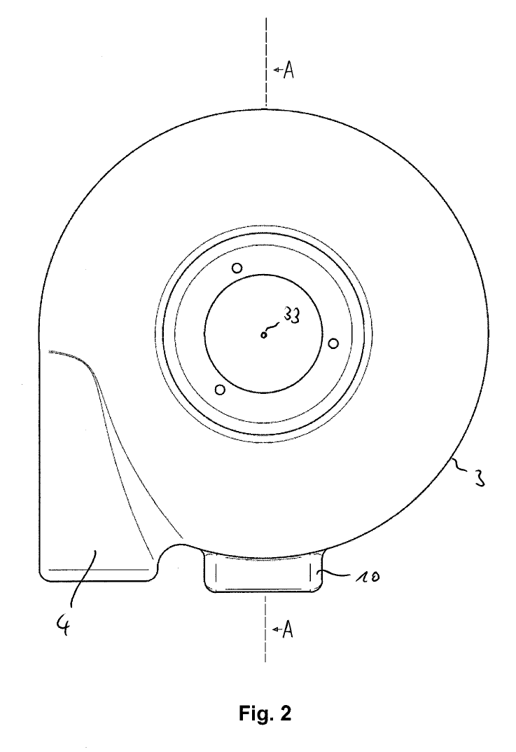

FIG. 2 is a top view of the suction device of FIG. 1,

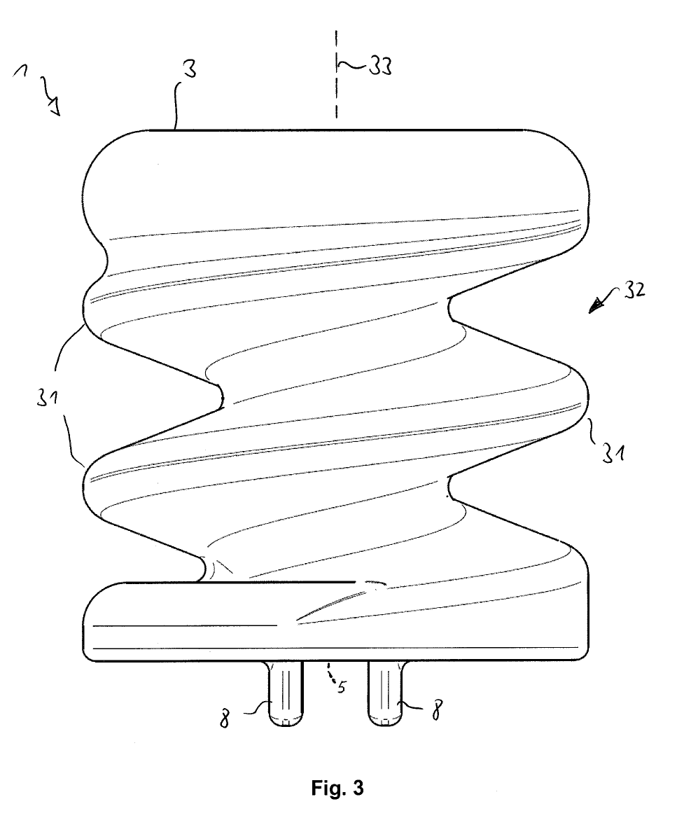

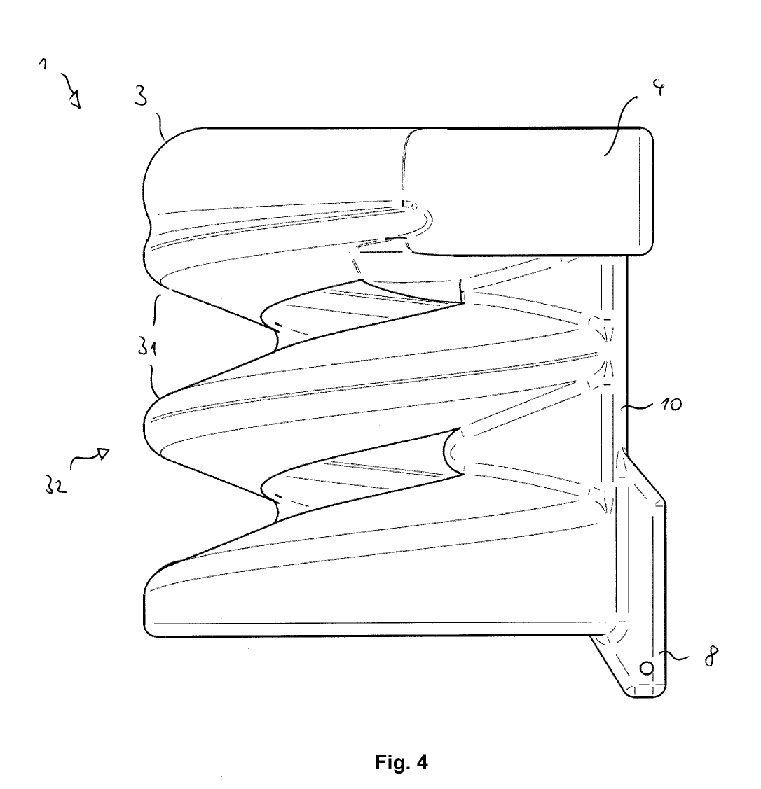

FIG. 3 is a front view of the suction device of FIG. 1, FIG. 4 is a side view of the suction device of FIG. 1,

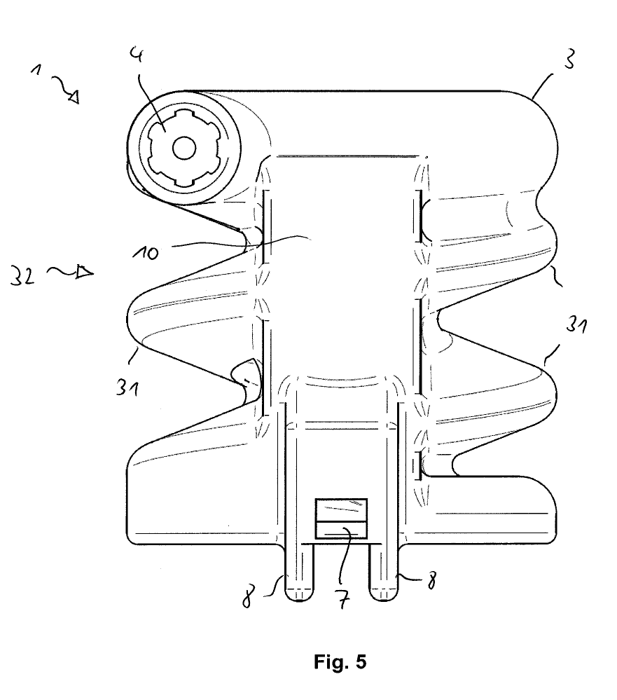

FIG. 5 is a rear view of the suction device of FIG. 1,

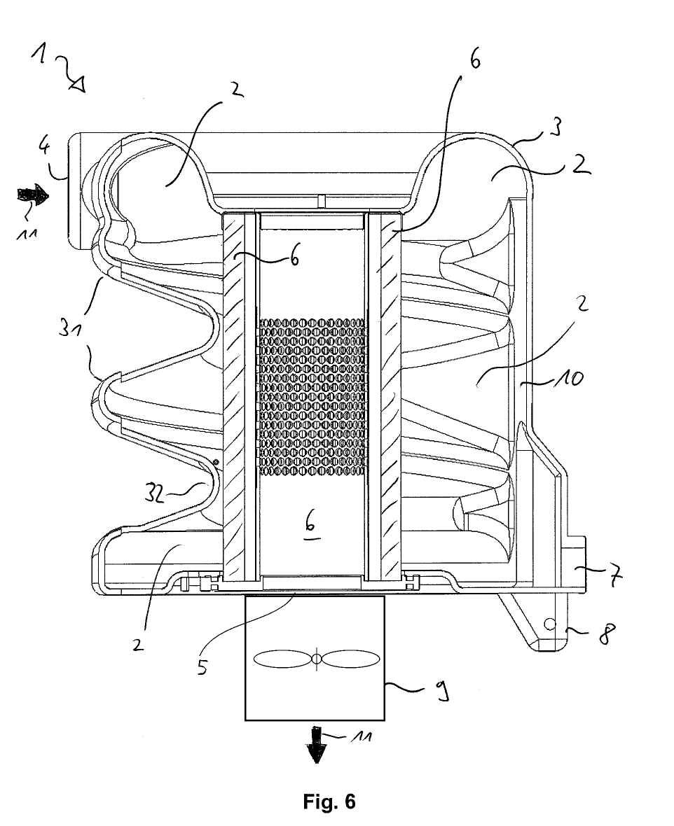

FIG. 6 is a schematic sectional view of the suction device of FIG. 2 in the direction A,

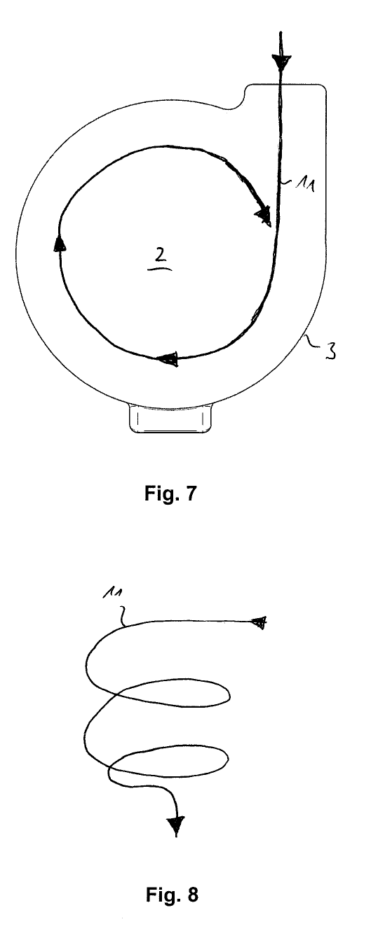

FIG. 7 is a schematic representation of the flow control from above seen on the suction device,

FIG. 8 is a schematic representation of the volume flow guide seen from the side, and

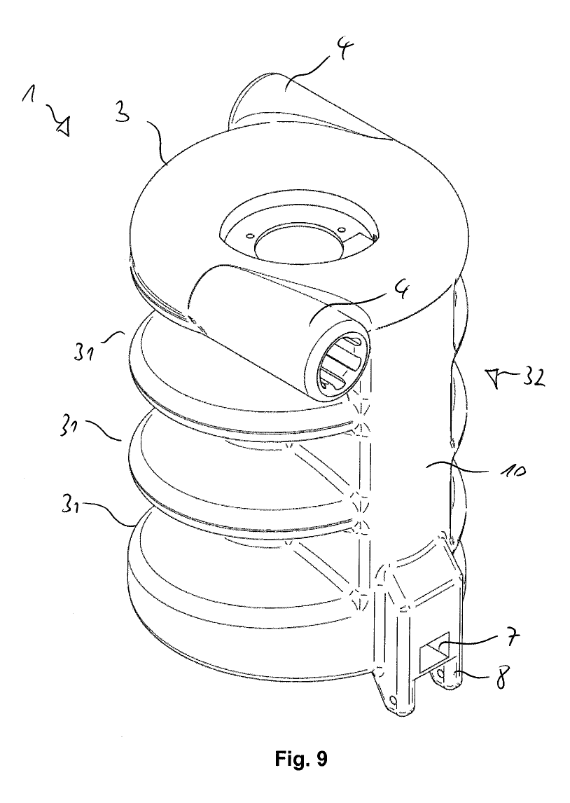

FIG. 9 shows a variant of a suction device with a plurality of volume flow inlets and a plurality of turns of the helical contour.

The same reference numerals in the figures designate the same or equivalent elements.

FIGS. 1 to 5 show different views of a suction device 1 according to the invention, with a housing 3 enclosing a process chamber 2 with a volume flow inlet 4 and a volume flow outlet 5 (see FIG. 3 or FIG. 6). In this case, the housing 3 directs the volume flow 11 (see FIGS. 6 to 8) and for this purpose has a helical contour 32 having a plurality of turns 31.

The volume flow inlet 4 at the upper end of the helical contour 32 is arranged so that the volume flow is introduced tangentially and is guided downwards along the helical contour 32 in the process chamber 2, the volume flow outlet 5 (see FIG. 3 or FIG. 6) is arranged on the screw axis 33 of the helical contour 32. The volume flow outlet 5 is arranged at the lower end of the housing 3 on the screw axis 33 of the helical contour 32.

In order to facilitate emptying of the process chamber filled with collected particles or liquid, a closable opening 7 for emptying the process chamber 2 is arranged in the lower region of the process chamber 2.

In order to facilitate collecting for solid and liquid substances separated from the volume flow 11, a dirt collecting formation 10 of the process chamber 2 is formed in the lower region of the housing.

In addition, a flange 8 is integrally formed in the lower region of the housing 3, which (can cooperate with a bearing not shown) formed on a holding device for the housing 3 in such a way that the housing 3 can be tilted via a bearing axis.

FIG. 6 shows a schematic cross-sectional view of the suction device 1 of FIG. 2 in the direction A. It can be seen that a filter body 6 is arranged in front of the volume flow outlet 5 in the interior of the process chamber 2, through which the volume flow 11 generated by the blower 9 is guided.

The illustration also clearly shows that the walls 31 forming the helical contour 32 of the housing 3 in the process chamber 2 abut the cylindrical filter body 6 inserted therein and are supported thereon. This enormously increases the pressure stability of the suction device.

FIGS. 7 and 8 show a diagrammatic representation of the volume flow guidance from above and schematically seen from the side on the suction device. Due to the centrifugal forces and thus due to the deposition of particles in and under the helical walls of the housing and by the filtering medium in the smallest chamber, a highly effective suction device can be suggested.

FIG. 9 shows one of several conceivable variants of an inventive suction device 1 with a plurality of volume flow inlets 4 and a plurality of turns 31.

### LIST OF REFERENCE SIGNS

1 Suction device
2 Process chamber
3 Housing
31 Turn
32 Helical contour
33 Screw axis
4 Volume flow inlet
5 Volume flow outlet
6 Filter body
7 Opening
8 Flange
9 Fan
10 Dirt collecting formation

1. A suction device (1) with a housing (3) surrounding a process chamber (2) with at least one volume flow inlet (4) and at least one volume flow outlet (5), wherein the housing (3) directs the volume flow and for this purpose has a helical contour (32) having at least one turn,
wherein said at least one volume flow inlet (4) is arranged at the upper end of the helical contour (32) characterised in
that the volume flow is introduced tangentially and is guided downwards along the helical contour (32) in the process chamber (2), wherein the volume flow outlet (5) is arranged on the screw axis of the helical contour (32), wherein a filter body (6) is arranged in front of the volume flow outlet (5) in the interior of the process chamber (2), through which the volume flow is guided.

2. A suction device according to claim 1, characterised in that the volume flow outlet (5) is arranged on the screw axis (33) of the helical contour (32) at the lower end of the housing (3),

3. A suction device according to claim 1 or 2, characterised in that a plurality of volume-flow inlets (4) are arranged at the upper end of the helical contour (32).

4. A suction device according to one of claims 1 to 3, characterised in
that a closable opening (7) for emptying the process chamber is arranged in the lower region of the process chamber (2).

5. A suction device according to one of claims 1 to 4, characterised in
in that the walls (31) of the housing (3) forming the helical contour (32) rest in the process chamber (2) against a cylindrical filter body (6) inserted therein.

6. A suction device according to one of claims 1 to 5, characterised in
that the housing (3) is formed of one piece or of two integral partial elements.

7. A suction device according to one of claims 1 to 6, characterised in
that a flange (8) is integrally formed in the lower region of the housing (3), which can cooperate with a bearing formed on a holding device for the housing (3) in such a way that the housing (3) can be tilted.

8. A suction device system according to one of claims 1 to 7, characterised in
that a fan (9) generating the volume flow is arranged after the volume flow outlet (5) at the lower end of the housing.

9. A suction device system according to one of claims 1 to 8, characterised in
that a dirt collecting formation (10) of the process chamber (2) is formed in the lower region of the housing for solids and liquids separated from the volume flow.
